(19) United States
(12) Patent Application Publication
(10) Pub. No.: US 2007/0270060 A1
(43) Pub. Date: Nov. 22, 2007

(54) Ultra Thin Laminated Panel

(76) Inventor: Sonny X.Y. HONG, Xiamen (CN)

Correspondence Address: BANGER SHIA, 204 CANYON CREEK, VICTORIA, TX, 77901-3695, US

(21) Appl. No.: 11/419,148

(22) Filed: May 18, 2006

(51) Int. Cl. B32B 17/02; B32B 27/12; B32B 17/04; B32B 27/04

(52) U.S. Cl. 442/29; 442/20; 442/180; 442/43; 442/2

(57) ABSTRACT

The present invention provides an ultra thin laminated panel, which is constructed of a flagstone layer and a fiber glass backing bonding together with an adhesive. Said fiber glass backing is compounded of laminated mesh grid woven out of crossing fibers, or bonding the mesh grids woven out of crossing fibers on the back side of the flagstone layer. In this structure, the intensity of the laminated panel can be improved, so it not only saves stone material and reducing weight, but also convenient to carrying over, transporting, constructing and paving, further to reducing the load to the building, so that it can be widely used.

### BACKGROUND OF THE INVENTION

1. Field of the Invention

The present invention relates to decoration building material, and more particularly to an ultra thin laminated panel.

2. Description of Prior Art

In accordance with the conventional flagstone in the market so far, they are cut off from the crude stone block, and then treated in grinding process and surface treatment process to manufacturing finished goods. For bonding the flagstones firmly and flatly in paving process, hammering out the surface of the flagstone facilitates to ramming down the bottom bed of the flagstone.

In view of manufacturing and paving the flagstones, for avoiding the flagstones breaking off as grinding and treating the surface and beating out the surface in paving, said flagstone is usually cut into a proper thickness so as to make the flagstone get certain intensity, so the thickness of the flagstone usually is 2˜3 cm, especially to bigger size, the thickness need to be increased.

The flagstone with so big thickness not only wastes stone material, but also is inconvenient to transportation and construction, due to the heavy flagstone, so that the conventional flagstone is used in a limited range.

### OBJECTS AND SUMMARY OF THE INVENTION

It is therefore a main object of the present invention to provide an ultra thin laminated panel that not only reinforced the intensity of the whole body, but also lighten the weight facilitating to transporting, constructing, paving, further to reducing the load to the building, and widening the application range.

For achieving the above-mentioned object, the present invention provides a resolution project as followings: offering an ultra thin laminated panel is constructed of a flagstone layer and a fiber glass backing bonding together with an adhesive.

Said fiber glass backing is compounded of laminated mesh grid woven out of crossing fibers, or bonding the mesh grids woven out of crossing fibers on the back side of the flagstone layer.

Said flagstone layer is usually cut into 2˜7 mm in thickness so that the laminated panel is bonded into about 2˜7 mm in thickness.

Said ultra thin laminated panel is manufactured bigger than 120 cm×240 cm in size.

As utilizing above-mentioned project, due to attaching a fiber glass backing on the back side of a single flagstone layer in the present invention, by the ultra thin cutting technology, said flagstone layer can be cut into enough thin (as about 2˜7 mm) and enough big size (as bigger than 120*240 cm) in manufacturing, bonding up said fiber glass backing on the back side of the flagstone layer can improve the intensity of the laminated panel.

The ultra thin laminated panel offered by the present invention has improved intensity to defend itself from whatever grinding, surface treating, or beating in paving without breaking off, not only save stone material and reducing weight, but also convenient to carrying over, transporting, constructing and paving, it can widely be used for decorating high building, large mansion and deluxe yacht so as to reduce the load of building greatly, and make the natural flagstone surface use in wider application range.

### BRIEF DESCRIPTION OF THE DRAWINGS

FIG. 1 is a sectional perspective view of the present invention.

FIG. 2 is a backside perspective view of FIG. 1.

FIG. 2a is a part-enlarged perspective view of FIG. 2.

FIG. 3 is a backside perspective view showing the second embodiment of the present invention.

FIG. 3a is a part-enlarged perspective view of FIG. 3.

### DETAILED DESCRIPTION OF PREFERRED EMBODIMENTS

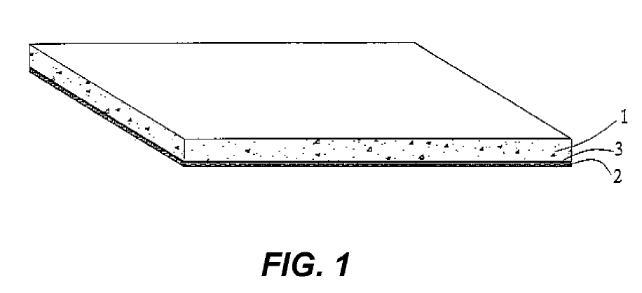

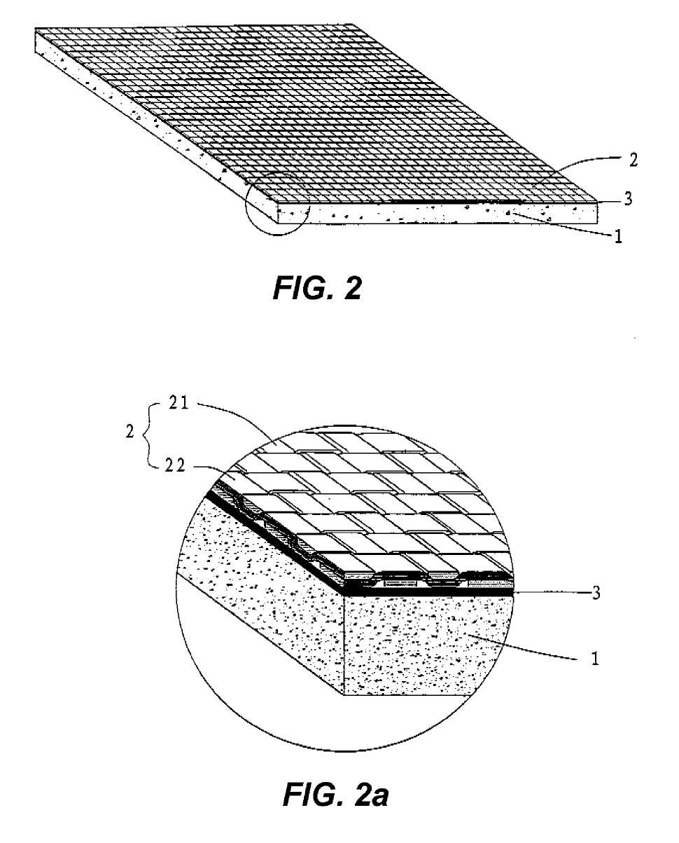

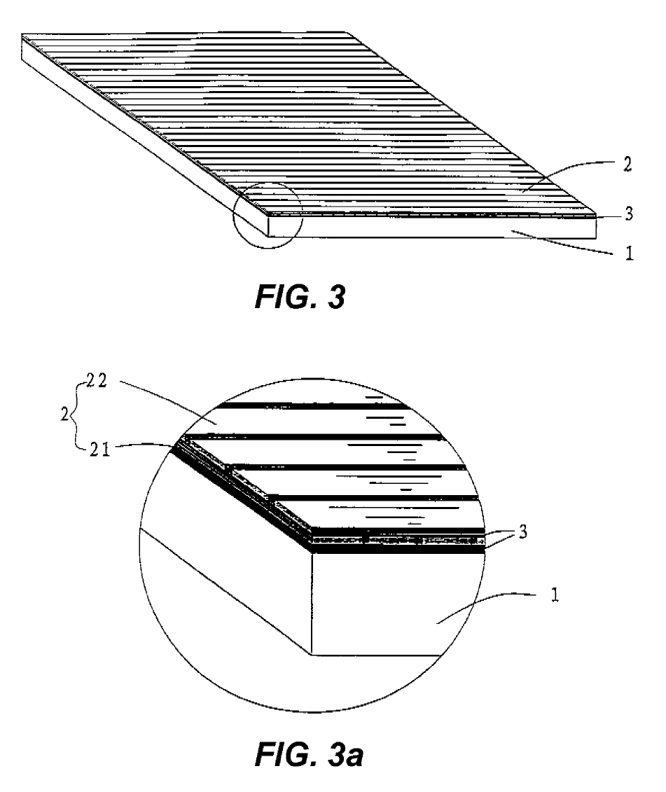

Referring to FIG. 1, an ultra thin laminated panel provided by the present invention is typically constructed of a flagstone layer 1 and a fiber glass backing 2 bonding together with adhesive 3.

Wherein, as shown in FIG. 2 and FIG. 2a, said fiber glass backing 2 is compounded of laminated mesh grid woven out of crossing fibers 21 22. As shown in FIG. 3 and FIG. 3a, said mesh grid woven out of crossing fibers 21 22 can be bonded on the back side of the flagstone layer 1 directly by said adhesive 3.

In manufacturing, by the ultra thin cutting technology, said flagstone layer 1 can be cut into enough thin (as about 2˜7 mm) so that the laminated panel is bonded with said fiber glass backing 2 into about 2˜7 mm in thickness, and the intensity of the ultra thin laminated panel can be improved greatly. And the laminated panel can be manufactured enough big in size (as bigger than 120*240 cm).

The ultra thin laminated panel offered by the present invention has improved intensity to defend itself from whatever grinding, surface treating, or beating in paving without breaking off, not only save stone material and reducing weight, but also convenient to carrying over, transporting, constructing and paving, it can widely be used for decorating high building, large mansion and deluxe yacht so as to reduce the load of building greatly, and make the natural flagstone surface use in wider application range.

I claim:

1. An ultra thin laminated panel constructed of a flagstone layer and a fiber glass backing bonding together with an adhesive.

2. An ultra thin laminated panel is constructed of a flagstone layer and a fiber glass backing bonding together with an adhesive, said fiber glass backing is a mesh grid woven of crossing fibers.

3. An ultra thin laminated panel is constructed of a flagstone layer and a fiber glass backing bonding together with an adhesive, said fiber glass backing is compounded of a mesh grid woven of crossing fibers bonded on the back side of the flagstone layer directly.

4. an ultra thin laminated panel as claimed in claim 1 to claim 3, wherein said flagstone layer is cut into 2˜7 mm so that the laminated panel is bonded into about 2˜7 mm in thickness.

5. an ultra thin laminated panel as claimed in claim 1 to claim 3, wherein said ultra thin laminated panel is manufactured bigger than 120 cm×240 cm in size.
